(19) United States
(12) Patent Application Publication
(10) Pub. No.: US 2013/0099568 A1
(43) Pub. Date: Apr. 25, 2013

(54) POWER SUPPLY CIRCUIT FOR MEMORY SLOTS

(71) Applicants: YA-JUN PAN, Shenzhen City (CN); TING GE, Shenzhen City (CN)

(72) Inventors: YA-JUN PAN, Shenzhen City (CN); TING GE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/325,545

(22) Filed: Dec. 14, 2011

(30) Foreign Application Priority Data
Oct. 19, 2011 (CN) 201110318410.7

(51) Int. Cl. H02J 1/00

(52) U.S. Cl. 307/31

(57) ABSTRACT

A power supply circuit for providing a voltage to a memory slot group with one or more memory slots includes a platform controller hub (PCH), a basic input/output system (BIOS), and a control circuit. The PCH detects whether any of the memory slots are occupied, and notifies the BIOS. If there are any memory slots are occupied, the BIOS enables a general purpose input/output (GPIO) terminal of the PCH. The control circuit controls a power supply to provide or not provide power to the memory slot group based on whether the GPIO terminal of the PCH is enabled.

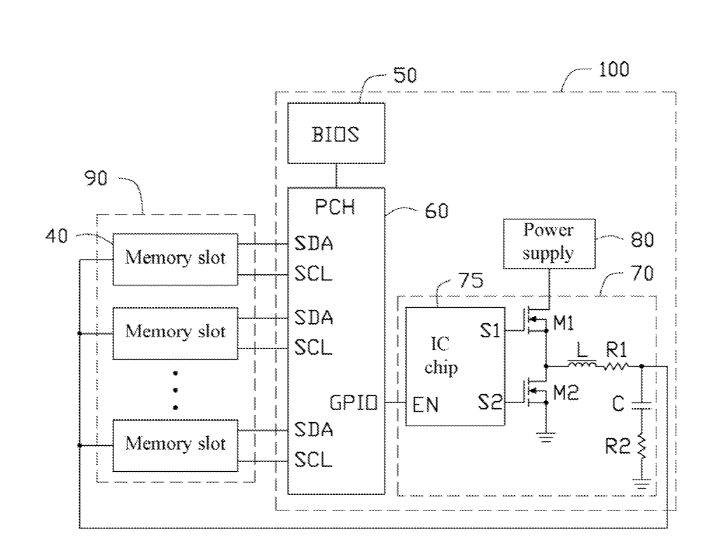

### BACKGROUND

1. Technical Field

The present disclosure relates to a power supply circuit for memory slots.

2. Description of Related Art

In general, a Sandy Bridge-EP central processing unit (CPU) is mounted between two groups of memory slots, and each group of the memory slots is controlled by a power supply controller. When the CPU operates, the memory slots operate simultaneously. Even if all the memory slots of a group are unoccupied, a memory power supply still provides a voltage to the idle memory slots through the corresponding memory power controller, which wastes energy.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The FIGURE is a circuit diagram of an exemplary embodiment of a power supply circuit.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

Referring to the FIGURE, a power supply circuit 100 is configured for providing a voltage to a memory slot group 90. An exemplary embodiment of the circuit 100 includes a platform controller hub (PCH) 60, a basic input/output system (BIOS) 50, a control circuit 70, and a power supply 80. The slot group 90 includes a plurality of memory slots 40, each of which is connected to a data terminal SDA and a clock terminal SCL of the PCH 60 through a system management bus (SMBUS). The slots 40 can receive memory chips (not shown).

The PCH 60 detects whether any of the slots 40 are occupied by a memory chip, and notifies the BIOS 50 if there are. If there are any slots 40 occupied by a memory chip the BIOS 50 enables a general purpose input/output (GPIO) terminal of the PCH 60.

The control circuit 70 includes an integrated circuit (IC) chip 75, metal-oxide-semiconductor field-effect transistors (MOSFETs) M1 and M2, an inductor L, resistors R1 and R2, and a capacitor C. An enable terminal EN of the IC chip 75 is connected to the GPIO terminal. A gate of the MOSFET M1 is connected to a signal terminal S1 of the IC chip 75, and a gate of the MOSFET M2 is connected to a signal terminal S2 of the IC chip 75. A drain of the MOSFET M1 is connected to the power supply 80. A source of the MOSFET M1 is connected to a drain of the MOSFET M2. The source of the MOSFET M1 is further grounded through the inductor L, the resistor R1, the capacitor C, and the resistor R2 connected in series. A node between the resistor R1 and the capacitor C is connected to all the memory slots 40. A source of the MOSFET M2 is grounded.

The control circuit 70 controls the power supply 80 to output or not output a voltage to the memory slot group 90 based on whether the GPIO terminal is enabled, which in turn enables the terminal EN. In this embodiment, when the terminal EN is not enabled, the control circuit 70 controls the power supply 80 to stop outputting a voltage to the slot group 90, and when the terminal EN is enabled, the control circuit 70 controls the power supply 80 to periodically output a voltage to the slot group 90 and to the inductor L and capacitor C.

In use, the PCH 60 detects whether the memory slots 40 are idle through the SMBUS. If the PCH 60 detects all the memory slots 40 are unoccupied, the PCH 60 sends a detection result to the BIOS 50. Based on the received detection result, the BIOS 50 does not enable the GPIO terminal, and no power is output by the power supply 80 because the IC chip 75 turns off the MOSFETs M1 and M2.

If the PCH 60 detects one or more memory chips are inserted in the memory slots 40, the BIOS 50 enables the output GPIO terminal which then outputs a high-level signal enabling the terminal EN. The signal terminals S1 and S2 alternately output a high-level signal. In detail, the IC chip 75 outputs a high-level signal to the MOSFET M1 through the signal terminal S1, and outputs a low-level signal to the MOSFET M2 through the signal terminal S2, thereby turning on the MOSFET M1 and turning off the MOSFET M2. The power supply 80 charges the inductor L and the capacitor C while at the same time supplying power to the slot group 90. After the inductor L and the capacitor C are charged, the IC chip 75 outputs a low-level signal to the MOSFET M1 through the signal terminal S1, and outputs a high-level signal to the MOSFET M2 through the signal terminal S2, thereby turning off the MOSFET M1 and turning on the MOSFET M2. The power supply 80 stops providing voltage to the slot group 90, while the inductor L and the capacitor C discharges to provide a voltage to the slot group 90 and then the cycle repeats.

The foregoing description of the exemplary embodiments of the disclosure has been presented only for the purposes of illustration and description and is not intended to be exhaustive or to limit the disclosure to the precise forms disclosed. Many modifications and variations are possible. The embodiments were chosen and described in order to explain the principles of the disclosure and their practical application so as to enable others of ordinary skill in the art to utilize the disclosure and various embodiments and with such various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A power supply circuit for providing a voltage to a memory slot group with one or more memory slots, comprising:
a platform controller hub (PCH) for detecting whether any of the memory slots are occupied, and outputting a notification if there are;
a basic input/output system (BIOS) for receiving the notification, if there are any memory slots occupied, the BIOS enables a terminal of the PCH;
a power supply; and
a control circuit connected between the power supply and the PCH, the control circuit controls the power supply to output or not output a voltage to the memory slot group based on whether the terminal of the PCH is enabled.

2. The power supply circuit of claim 1, wherein when the terminal of the PCH is not enabled, the control circuit control the power supply to stop outputting a voltage to the memory slot group, when the terminal of the PCH is enabled, the control circuit controls the power supply to output a voltage to the memory slot group.

3. The power supply circuit of claim 1, wherein the control circuit comprises an integrated circuit (IC) chip, a first and a second metal-oxide-semiconductor field-effect transistors (MOSFETs), an inductor, a first and a second resistors, and a capacitor. An enable terminal of the IC chip is connected to the output terminal of the PCH, a gate of the first MOSFET is connected to a first signal terminal of the IC chip, a drain of the first MOSFET is connected to the power supply, a source of the first MOSFET is connected to a drain of the second MOSFET, a gate of the second MOSFET is connected to a second signal terminal of the IC chip, the source of the first MOSFET is further grounded through the inductor, the first resistor, the capacitor, and the second resistor connected in series, a node between the first resistor and the capacitor is connected to all the memory slots, a source of the second MOSFET is grounded.

4. The power supply circuit of claim 1, wherein the terminal of the PCH is a general purpose input/output terminal.

5. The power supply circuit of claim 1, wherein a data terminal and a clock terminal of the PCH are connected to each memory slot through a system management bus.
